(19) United States
(12) Patent Application Publication
(10) Pub. No.: US 2015/0167615 A1
(43) Pub. Date: Jun. 18, 2015

(54) Motor Control Device

(71) Applicant: Hitachi Automotive Systems, Ltd., Hitachinaka-shi, Ibaraki (JP)

(72) Inventors: Atsushi Komuro, Hitachinaka-shi (JP); Fumihiro Itaba, Hitachinaka-shi (JP); Kentaro Shiga, Hitachinaka-shi (JP)

(21) Appl. No.: 14/413,250

(22) PCT Filed: Jun. 19, 2013
(86) PCT No.: PCT/JP2013/066773

§ 371 Date: Jan. 7, 2015

(30) Foreign Application Priority Data
Jul. 31, 2012 (JP) 2012-170128

(51) Int. Cl. F02N 11/08; B60L 3/04

(52) U.S. Cl. CPC F02N 11/0848; F02N 11/0851; B60L 3/04

(57) ABSTRACT

If the control of a motor becomes impossible, the motor appropriately stops, and drive wheels are driven by an engine to enable retraction travel. A motor/generator 4 is used to drive drive wheels of a vehicle, and start an engine 3. A motor controller 22 implements a first control mode for controlling the motor/generator 4 on the basis of a command from an integrated controller 20 if a CAN communication with the integrated controller 20 is normal. The motor controller 22 implements a second control mode for controlling the motor/generator 4 on the basis of control information stored in advance to allow the motor/generator 4 to start the engine 3 when the engine 3 is in stop if the CAN communication with the integrated controller 20 is abnormal.

### TECHNICAL FIELD

The present invention relates to a motor control device that controls a motor driven by a battery.

### BACKGROUND ART

Up to now, there has been known a hybrid electric vehicle of one motor and two clutches including a first clutch disposed between an engine and a motor, and a second clutch disposed between the motor and drive wheels (PTL 1).

In the hybrid electric vehicle disclosed in PTL 1, the components of the engine, the motor, the first clutch, and the second clutch are controlled by respective dedicated controllers. Those respective dedicated controllers are connected to an integrated controller through a CAN communication line, the control of the corresponding components is implemented on the basis of commands from the integrated controller.

### CITATION LIST

### Patent Literature

PTL 1: JP-A-2011-20543

### SUMMARY OF INVENTION

### Technical Problem

In the hybrid electric vehicle of one motor and two clutches as described above, if a command from the integrated controller cannot be normally received by the motor controller due to a communication failure, and the motor cannot be controlled, it is preferable that the motor stops, and the drive wheels are driven by the engine to perform retraction travel for safety reasons. However, Patent Literature 1 fails to disclose any control method in this case.

### Solution to Problem

According to one aspect of the present invention, there is provided a motor control device that is mounted on a vehicle which is a hybrid electric vehicle having an engine and a motor, and controls the motor, in which the motor is used to drive drive wheels of the vehicle, and start the engine. The vehicle includes the motor control device, an engine control device that controls the engine, and an integrated control device that is communicatively connected to the motor control device and the engine control device, and outputs a command corresponding to a driving state of the vehicle to the motor control device and the engine control device. The motor control device implements a first control mode for controlling the motor on the basis of the command from the integrated control device if a communication with the integrated control device is normal, and implements a second control mode for controlling the motor on the basis of control information stored in advance to allow the motor to start the engine when the engine is in stop if the communication with the integrated control device is abnormal.

Also, according to another aspect of the present invention, there is provided a motor control device that is mounted on a vehicle which is a hybrid electric vehicle having an engine and a motor, and controls the motor, in which if a communication with an external control device is abnormal, a first control mode for controlling the motor on the basis of a command from the external control device is switched to a second control mode for controlling the motor on the basis of control information stored in advance.

### Advantageous Effects of Invention

According to the present invention, if the control of the motor becomes impossible, the motor appropriately stops, and the drive wheels are driven by the engine to enable retraction travel.

### BRIEF DESCRIPTION OF DRAWINGS

FIG. 1 is a diagram illustrating a configuration of a hybrid electric vehicle having a motor controller mounted thereon as an embodiment of a motor control device according to the present invention.

FIG. 2 is a control block diagram of the motor controller.

FIG. 3 is a calculation block diagram of a torque command value in the motor controller.

FIG. 4 is a flowchart of a motor control process executed in the motor controller.

FIG. 5 is a flowchart of an engine start control process.

FIG. 6 is a flowchart of a rotation speed control completion determination process.

FIG. 7 is a flowchart of a second clutch control process in a standby time.

FIG. 8 is a flowchart of a first clutch control process at the time of selecting a second control mode.

FIG. 9 is a diagram illustrating an example of a rotation speed change rate at the time of selecting the second control mode.

FIG. 10 is a diagram illustrating an example of an operation time chart when a CAN communication is interrupted.

### DESCRIPTION OF EMBODIMENTS

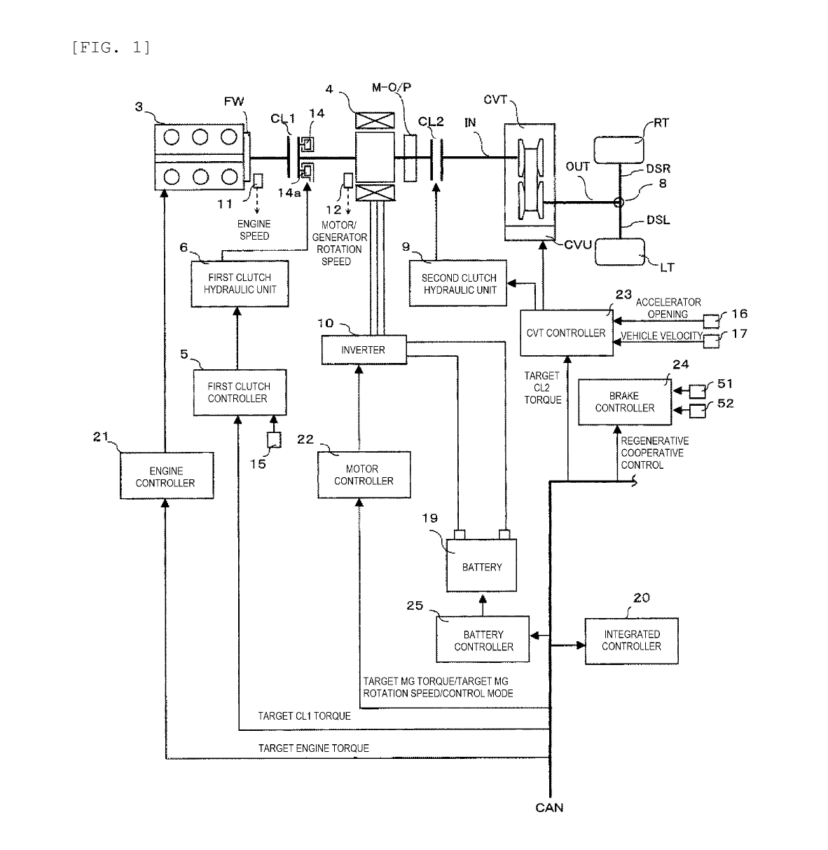

An embodiment of the present invention will be described below with reference to the drawings. FIG. 1 is a diagram illustrating a configuration of a hybrid electric vehicle having a motor controller mounted thereon as an embodiment of a motor control device according to the present invention.

A drive system of the hybrid electric vehicle includes, as illustrated in FIG. 1, an engine 3, a flywheel FW, a first clutch CL1, a motor/generator 4, a mechanical oil pump M-O/P, a second clutch CL2, an automatic transmission CVT, a transmission input shaft IN, a transmission output shaft OUT, a differential 8, a left drive shaft DSL, a right drive shaft DSR, and a left tire LT and a right tire RT which are drive wheels.

The engine 3 is an internal combustion engine such as a gasoline engine or a diesel engine, and operates on the basis of an engine control command from an engine controller 21. The engine controller 21 is a device for controlling the engine 3, and subjects the engine 3 to, for example, an engine start control, an engine stop control, a valve opening control of throttle valves, and a fuel cut control, to thereby control the operation of the engine 3.

The first clutch CL1 is a clutch for engaging or disengaging between the engine 3 and the motor/generator 4, and is interposed between those components. A first clutch controller 5 outputs a first clutch control command for controlling the operation of the first clutch CL1 to a first clutch hydraulic unit 6 incorporated into a hydraulic control valve unit CVU which will be described later. The first clutch hydraulic unit 6 generates a first clutch control hydraulic pressure on the basis of the first clutch control command from the first clutch controller 5, and outputs the first clutch control hydraulic pressure to the first clutch CL1. The first clutch CL1 is controlled to any one of an engagement state, a semi-engagement state (slip engagement state), and a disengagement state according to the first clutch control hydraulic pressure. The first clutch CL1 is formed of, for example, a normally closed dry-type single plate clutch that controls the engagement state under a stroke control using hydraulic actuators 14 with pistons 14a, and keeps perfect engagement by an urging force of a diaphragm sprig.

The motor/generator 4 is a synchronous motor/generator in which permanent magnets are embedded in a rotor, and a stator coil is wound around a stator. A motor controller 22 outputs a control command for controlling the motor/generator 4 to an inverter 10. The inverter 10 generates a three-phase AC power with the use of a DC power supplied from a battery 19 on the basis of the control command from the motor controller 22, and supplies the three-phase AC power to the motor/generator 4. The rotating state of the motor/generator 4 is controlled according to the three-phase AC power. In this way, the motor/generator 4 is rotationally driven upon receiving the supply of a power from the battery 19, and performs power running operation so as to operate as an electric motor for driving the drive wheels. Further, the motor/generator 4 generates an electromotive force on both ends of the stator coil upon receiving a rotational energy from the engine 3 and the drive wheels with the rotor, and can charge the battery 19. In this case, the motor/generator 4 functions as a power generator for performing regenerative operation.

The mechanical oil pump M-O/P is disposed on a rotating shaft of the motor/generator 4, and driven by the motor/generator 4. The mechanical oil pump M-O/P is a hydraulic source for the hydraulic control valve unit CVU attached to the automatic transmission CVT, and the first clutch hydraulic unit 6, and a second clutch hydraulic unit 9 which are incorporated into the hydraulic control valve unit CVU. Taking a case in which a discharge hydraulic pressure from the mechanical oil pump M-O/P cannot be sufficiently expected into account, an electric oil pump driven by the electric motor may be further provided.

The second clutch CL2 is a clutch for engaging or disengaging between the motor/generator 4 and the left tire LT and the right tire RT which are the drive wheels, and is interposed between the rotating shaft of the motor/generator 4 and the transmission input shaft IN. A CVT controller 23 outputs a second clutch control command for controlling the operation of the second clutch CL2 to the second clutch hydraulic unit 9 incorporated into the hydraulic control valve unit CVU. The second clutch hydraulic unit 9 generates a second clutch control hydraulic pressure on the basis of the second clutch control command from the CVT controller 23, and outputs the second clutch control hydraulic pressure to the second clutch CL2. The second clutch CL2 is controlled to any one of an engagement state, a semi-engagement state (slip engagement state), and a disengagement state according to the second clutch control hydraulic pressure. The second clutch CL2 is formed of a normally open wet-type multiple plate clutch that can continuously control an oil flow rate and a hydraulic pressure by a proportional solenoid.

The automatic transmission CVT is a continuously variable transmission of a belt type which can automatically change a transmission gear ratio steplessly, and disposed at a downstream position of the second clutch CL2. The transmission gear ratio in the automatic transmission CVT is adjusted by the determination of a target input rotation speed according to a vehicle velocity or an accelerator opening. The automatic transmission CVT mainly includes a primary pulley on the transmission input shaft IN side, a secondary pulley on the transmission output shaft OUT side, and a belt that extends around both of those pulleys. A primary pulley pressure and a secondary pulley pressure are created on the basis of a hydraulic pressure supplied from the mechanical oil pump M-O/P, and a movable pulley of the primary pulley and a movable pulley of the secondary pulley move in the respective axial directions due to those pulley pressures to change a pulley contact radius of the belt, as a result of which the transmission gear ratio can be changed steplessly in the automatic transmission CVT.

The hybrid electric vehicle configured as described above selectively uses three kinds of travel modes including an electric vehicle travel mode (hereinafter referred to as “EV mode”), a hybrid electric vehicle travel mode (hereinafter referred to as “HEV mode”), and a drive torque control travel mode (hereinafter referred to as “WSC mode”) due to a difference in drive configuration. The WSC is an abbreviation for “wet start clutch”.

The EV mode is a mode in which the first clutch CL1 is in the disengagement state, and the vehicle travels with the motor/generator 4 as a drive source. The EV mode is further classified into a motor travel mode in which the motor/generator 4 performs power running operation, and a regenerative travel mode in which the motor/generator 4 performs the regenerative travel. The hybrid electric vehicle selects any one of those modes, and travel in the selected mode. The EV mode is selected when a drive force required for the drive wheels is relatively low, and an SOC (state of charge) indicative of a charging capacity of the battery 19 is sufficiently ensured.

The HEV mode is a mode in which the first clutch CL1 is in the engagement state, and the vehicle travels with the engine 3 and the motor/generator 4 as the drive sources. The HEV mode is further classified into a motor assist travel mode in which the drive wheels are driven with the use of the engine 3 and the motor/generator 4 at the same time, a power generation travel mode in which a power is generated by the motor/generator 4 while the drive wheels are driven with the use of the engine 3, and an engine travel mode in which the drive wheels are driven with the use of only the engine 3. The hybrid electric vehicle selects any one of those modes, and travels in the selected mode. The HEV mode is selected when the drive force required for the drive wheels is relatively high, or the SOC of the battery 19 is short.

The WSC mode is a mode in which the second clutch CL2 is maintained in the slip engagement state while performing the rotation speed control of the motor/generator 4, and the vehicle travels while controlling a clutch torque capacity of the second clutch CL2 so that the torque transmitted to the transmission input shaft IN through the second clutch CL2 matches the required drive torque determined according to a vehicle state or driver's operation. The WSC mode is selected in a travel region where an engine speed is reduced below an idling speed, for example, the vehicle stops, the vehicle starts, or the vehicle is decelerated, in a state where the HEV mode is selected, or a discharge hydraulic pressure from the mechanical oil pump M-O/P is short.

Subsequently, a control system of the hybrid electric vehicle will be described. The control system of the hybrid electric vehicle includes, as illustrated in FIG. 1, the engine controller 21, the motor controller 22, the inverter 10, the battery 19, the first clutch controller 5, the first clutch hydraulic unit 6, the CVT controller 23, the second clutch hydraulic unit 9, a brake controller 24, a battery controller 25, and an integrated controller 20. The respective controllers of the engine controller 21, the motor controller 22, the first clutch controller 5, the CVT controller 23, the brake controller 24, the battery controller 25, and the integrated controller 20 are connected to each other through a CAN communication line that enables information exchange with each other.

The engine controller 21 receives engine speed information from an engine speed sensor 11, a target engine torque command from the integrated controller 20, and other necessary information. Then, the engine controller 21 outputs a command for controlling an engine speed Ne and an engine torque Te representing an engine operating point to a throttle valve actuator of the engine 3 on the basis of those pieces of information to control the engine 3.

The motor controller 22 receives rotor position information (rotation speed information) from a resolver 12 that detects a rotor rotation position of the motor/generator 4, a target MG torque command, a target MG rotation speed command, and a control mode command from the integrated controller 20, and other necessary information. On the basis of those pieces of information, the motor controller 22 selects a control mode corresponding to any travel mode of the EV mode, the HEV mode, and the WSC mode described above, generates a PWM signal, and outputs the PWM signal to the inverter 10. The motor controller 22 operates the inverter 10 according to the PWM signal to control the motor/generator 4. During the travel of the hybrid electric vehicle, the motor controller 22 controls the motor/generator 4 with a motor torque Tm as a target torque, and basically performs a torque control for allowing a motor rotation speed Nm to follow the rotation of a drive system. However, when the motor controller 22 subjects the second clutch CL2 to a slip control in the above-mentioned WSC mode, the motor controller 22 controls the motor/generator 4 with the motor rotation speed Nm as the target rotation speed, and performs the rotation speed control for allowing the motor torque Tm to follow a load of the drive system.

The battery controller 25 monitors the SOC indicative of the charging capacity of the battery 19, and supplies information on the SOC based on the monitoring results and information on a power which can be input and output with respect to the battery 19 to the integrated controller 20 through the CAN communication line.

The first clutch controller 5 receives sensor information from a first clutch stroke sensor 15 for detecting a stroke position of the pistons 14a in the hydraulic actuators 14, a target CL1 torque command from the integrated controller 20, and other necessary information. On the basis of those pieces of information, the first clutch controller 5 outputs a command for controlling the engagement state of the first clutch CL1 to the first clutch hydraulic unit 6 within the hydraulic control valve unit CVU, to thereby control the first clutch CL1.

The CVT controller 23 receives accelerator opening information from an accelerator opening sensor 16, vehicle velocity information from a vehicle velocity sensor 17, and various pieces of information output from other sensors as occasion demands. On the basis of those pieces of information, when a D range is selected by a shift lever not shown, the CVT controller 23 searches the accelerator opening and a target input rotation speed determined by the vehicle velocity from a shift map, and outputs a control command for obtaining a transmission gear ratio corresponding to the searched target input rotation speed to the hydraulic control valve unit CVU, to thereby perform a transmission control of the automatic transmission CVT. When a transmission control command is output from the integrated controller 20 at the time of starting the engine or at the time of stopping the engine, the CVT controller 23 performs the transmission control responsive to the transmission control command in preference to the normal transmission control described above. Further, when the CVT controller 23 receives a target CL2 torque command from the integrated controller 20, the CVT controller 23 controls the second clutch CL2 in addition to the above transmission control. In this situation, the CVT controller 23 outputs a command for controlling the clutch hydraulic pressure for the second clutch CL2 to the second clutch hydraulic unit 9 within the hydraulic control valve unit CVU to control the second clutch CL2 on the basis of the target CL2 torque command.

The brake controller 24 receives vehicle velocity information from a wheel speed sensor 51 for detecting the respective four wheel speeds of the vehicle, brake stroke information from a brake stroke sensor 52 for detecting the amount of depression of a brake pedal, a regenerative cooperative control command from the integrated controller 20, and other necessary information. Then, the brake controller 24 performs the brake control on the basis of the above information. For example, if only the regenerative brake force is insufficient for the required brake force obtained from the brake stroke during the brake depression braking, the brake controller 24 performs the regenerative cooperative brake control so as to compensate the shortage with a mechanical braking force (a hydraulic braking force or a motor braking force).

The integrated controller 20 manages an energy consumption of the overall vehicle, and assumes a function for allowing the vehicle to travel at the highest efficiency. The integrated controller 20 receives various pieces of information from the motor rotation speed sensor for detecting the motor rotation speed Nm, and other sensors and switches, and information output from the respective controllers through the CAN communication line. Then, the integrated controller 20 selects any travel mode of the above-mentioned three kinds of travel modes on the basis of those pieces of information, and outputs a command corresponding to the selected travel mode to the respective other controllers. Specifically, the integrated controller 20 outputs the target engine torque command to the engine controller 21, outputs the target MG torque command, the target MG rotation speed command, and the control mode command to the motor controller 22, outputs the target CL1 torque command to the first clutch controller 5, outputs the target CL2 torque command to the CVT controller 23, and outputs the regenerative cooperative control command to the brake controller 24.

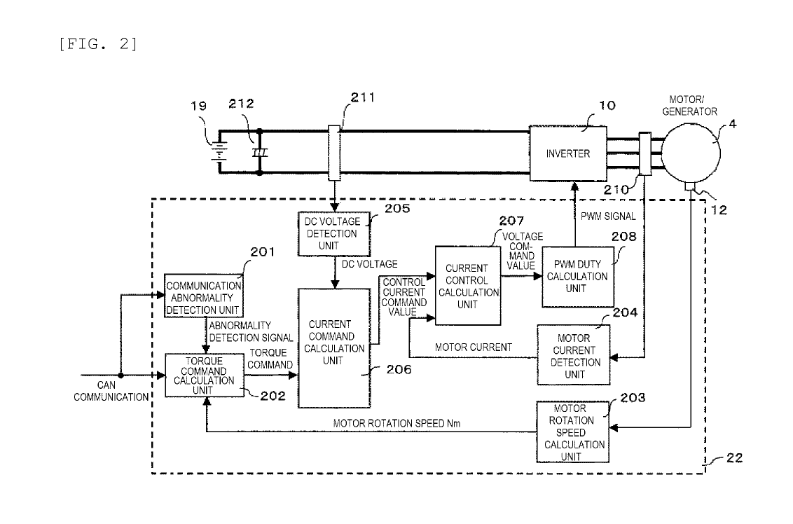

Subsequently, the control contents performed by the motor controller 22 will be described. FIG. 2 is a control block diagram of the motor controller 22. As illustrated in FIG. 2, the motor controller 22 functionally includes the respective control blocks of a communication abnormality detection unit 201, a torque command calculation unit 202, a motor rotation speed calculation unit 203, a motor current detection unit 204, a DC voltage detection unit 205, a current command calculation unit 206, a current control calculation unit 207, and a PWM duty calculation unit 208. The motor controller 22 can realize those respective control blocks by processing of a microcomputer.

The communication abnormality detection unit 201 detects a state of a CAN communication with the integrated controller 20, and determines whether the state is normal or abnormal. As a result, if the communication abnormality detection unit 201 determines that the CAN communication is abnormal, the communication abnormality detection unit 201 outputs an abnormality detection signal to the torque command calculation unit 202.

The torque command calculation unit 202 receives the target MG torque command, the target MG rotation speed command, and the control mode command which are transmitted from the integrated controller 20 through the CAN communication, and also receives the calculation results of the motor rotation speed Nm by the motor rotation speed calculation unit 203. Then, the torque command calculation unit 202 calculates a torque command for the motor/generator 4 on the basis of those respective values, and outputs the calculated torque command to the current command calculation unit 206. A method of calculating the torque command by the torque command calculation unit 202 will be described in detail later.

If the abnormality detection signal is output from the communication abnormality detection unit 201 to the torque command calculation unit 202, the torque command calculation unit 202 calculates the torque command in a method different from that in the normal state for the purpose of allowing the hybrid electric vehicle to perform the retraction travel. A specific calculation method in this case will be described in detail later.

The motor rotation speed calculation unit 203 receives the rotor position information from the resolver 12, and calculates the motor rotation speed Nm indicative of the rotation speed of the motor/generator 4 on the basis of the rotor position information. Then, the motor rotation speed calculation unit 203 outputs the calculated motor rotation speed Nm to the torque command calculation unit 202.

The motor current detection unit 204 detects a motor current that flows into the motor/generator 4 from the inverter 10 on the basis of the sensor information from a current sensor 210 disposed between the inverter 10 and the motor/generator 4. Then, the motor current detection unit 204 outputs a detected current value to the current control calculation unit 207.

The DC voltage detection unit 205 detects a DC voltage supplied from the battery 19 to the inverter 10 on the basis of sensor information from a voltage sensor 211 disposed between the inverter 10 and the battery 19. Then, the DC voltage detection unit 205 outputs a detected voltage value to the current command calculation unit 206. The voltage sensor 211 measures a voltage across a capacitor 212 connected in parallel to the battery 19 as a DC voltage applied to the inverter 10 from the battery 19. In this example, the voltage across the capacitor 212 has the same value as a voltage across the battery 19 in theory.

The current command calculation unit 206 determines a control current command value for controlling a current output from the inverter 10 to the motor/generator 4 on the basis of the torque command from the torque command calculation unit 202 and the voltage value from the DC voltage detection unit 205. Then, the current command calculation unit 206 outputs the control current command value to the current control calculation unit 207.

The current control calculation unit 207 compares the control current command value from the current command calculation unit 206 with the current value from the motor current detection unit 204, and determines a voltage command value for the inverter 10 on the basis of the comparison results. Then, the current control calculation unit 207 outputs the voltage command value to the PWM duty calculation unit 208.

The PWM duty calculation unit 208 determines the duties of the PWM control for the respective switching elements provided in the inverter 10 on the basis of the voltage command value from the current control calculation unit 207. Then, the PWM duty calculation unit 208 generates PWM signals corresponding to the determined duties of the respective switching elements, and outputs the PWM signals to the inverter 10. The respective switching elements of the inverter 10 perform the switching operation according to the PWM signal with the results that a DC power from the battery 19 is converted into a three-phase AC power, and output to the motor/generator 4.

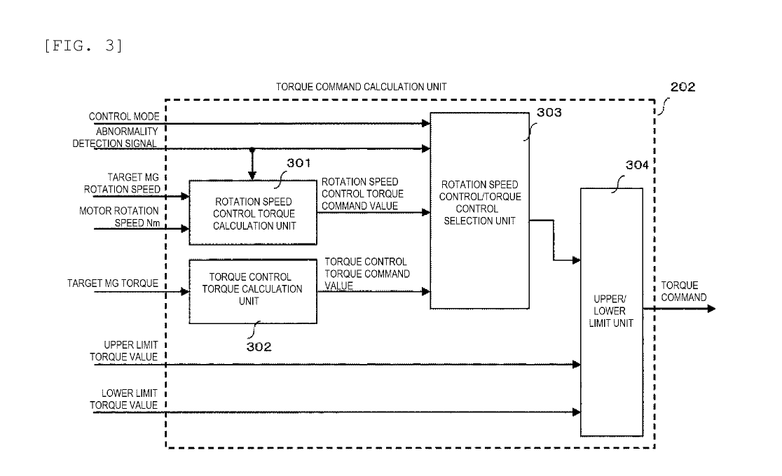

Subsequently, a method of calculating the torque command by the torque command calculation unit 202 will be described. FIG. 3 is a control block diagram of the torque command calculation unit 202. As illustrated in FIG. 3, the torque command calculation unit 202 functionally includes the respective control blocks of a rotation speed control torque calculation unit 301, a torque control torque calculation unit 302, a rotation speed control/torque control selection unit 303, and an upper/lower limit unit 304.

The rotation speed control torque calculation unit 301 compares the target MG rotation speed designated by the target MG rotation speed command, which is transmitted from the external integrated controller 20 through the CAN communication, with the motor rotation speed Nm from the motor rotation speed calculation unit 203 to calculate a torque command value so that the motor rotation speed Nm matches the target MG rotation speed. The torque command value is output to the rotation speed control/torque control selection unit 303 as a rotation speed control torque command value.

If the CAN communication performed between the integrated controller 20 and the motor controller 22 is abnormal, the abnormality is detected by the communication abnormality detection unit 201 to output the abnormality detection signal as described above. In this situation, the rotation speed control torque calculation unit 301 cannot obtain the target MG rotation speed from the integrated controller 20. For that reason, when the abnormality detection signal is output from the communication abnormality detection unit 201, the rotation speed control torque calculation unit 301 calculates the torque command value described above with the use of the rotation speed stored in advance as control information when the abnormality occurs, instead of the target MG rotation speed from the integrated controller 20 in response to the abnormality detection signal. This calculation will be described in detail later.

The torque control torque calculation unit 302 subjects a target MG torque value designated by the target MG torque command, which is transmitted from the integrated controller through the CAN communication, to a given correction calculation or a change rate limit, to calculate the torque command value. The torque command value is output to the rotation speed control/torque control selection unit 303 as a torque control torque command value.

The rotation speed control/torque control selection unit 303 receives the rotation speed control torque command value from the rotation speed control torque calculation unit 301, and the torque control torque command value from the torque control torque calculation unit 302, and selects any one of those torque command values. Then, the rotation speed control/torque control selection unit 303 outputs the selected torque command value to the upper/lower limit unit 304. The torque command value is selected as follows on the basis of the control mode command transmitted from the integrated controller 20 through the CAN communication, and the abnormality detection signal output from the communication abnormality detection unit 201.

If the abnormality detection signal is not output from the communication abnormality detection unit 201, the rotation speed control/torque control selection unit 303 selects the rotation speed control torque command value if the rotation speed control is executed, and selects the torque control torque command value if the torque control is executed, according to the control mode designated by the control mode command. In the control mode command, the control mode corresponding to the determination of the integrated controller 20 is designated. For example, during the travel in the EV mode, or during the travel in the HEV mode, the torque control is designated by the integrated controller 20. During the travel in the WSC mode, and in the shift from the travel in the EV mode to the HEV mode with the start of the engine 3, the rotation speed control is designated by the integrated controller 20.

On the other hand, if the abnormality detection signal is output from the communication abnormality detection unit 201, the rotation speed control/torque control selection unit 303 selects the rotation speed control torque command value regardless of the control mode designated by the control mode command. As described above, the rotation speed control torque command value is calculated with the use of the rotation speed stored in advance in the rotation speed control torque calculation unit 301.

The upper/lower limit unit 304 limits the torque command value from the rotation speed control/torque control selection unit 303 as occasion demands, on the basis of an upper limit torque value and a lower limit torque value which are transmitted from the integrated controller 20 through the CAN communication. For example, a limit width corresponding to the upper limit torque value and the lower limit torque value is set, and if the torque command value falls outside the limit width, the torque command value is limited to the upper limit torque value or the lower limit torque value, and output. As a result, a final torque command output from the torque command calculation unit 202 is determined.

Subsequently, a mode transition operation of the vehicle will be described. If the integrated controller 20 determines that the mode should be shifted to the HEV mode on the basis of the remaining amount of SOC or the torque request during the travel in the EV mode, the integrated controller 20 shifts the mode to the HEV mode through the engine start control. In the engine start control, the integrated controller 20 puts the first clutch CL1 disengaged in the EV mode into the semi-engagement state, and cranks the engine 3 with the motor/generator 4 as a starter motor to start the engine 3 by fuel injection and ignition. Thereafter, the integrated controller 20 engages the first clutch CL1. When the engine start control starts, the integrated controller 20 outputs the control mode command for designating the rotation speed control to the motor controller 22, to thereby change the motor/generator 4 from the torque control to the rotation speed control so as to perform the cranking or the rotation synchronization of the engine 3. Also, the integrated controller 20 slip-engages the second clutch CL2, to thereby absorb a torque variation associated with the engine start control by the second clutch CL2, and prevent an engine start shock caused by the torque transmission to the drive shaft.

On the other hand, if the integrated controller 20 determines that the mode should be shifted to the EV mode during the travel in the HEV mode, the integrated controller 20 performs the engine stop control, and shifts to the EV mode. In the engine stop control, after the integrated controller 20 has disengaged the first clutch CL1 engaged during the HEV mode, the integrated controller 20 stops the engine 3 separated from the drive shafts. During the execution of the engine stop control, the integrated controller 20 outputs the control mode command for designating the rotation speed control to the motor controller 22 as with the above-mentioned engine start control, to thereby change the motor/generator 4 from the torque control to the rotation speed control. Also, the integrated controller 20 slip-engages the second clutch CL2 to absorb a torque variation associated with the engine stop control with the second clutch CL2, and prevent the engine stop shock caused by the torque transmission to the drive shafts.

As described above, when transitioning from the EV mode to the HEV mode, or transitioning from the HEV mode to the EV mode, there is a need to implement the control in the respective controllers while exchanging information among the respective controllers of the engine controller 21, the motor controller 22, the first clutch controller 5, the CVT controller 23, the brake controller 24, the battery controller 25, and the integrated controller 20. In general, information is transmitted and received with respect to the respective controllers through the CAN communication.

In this situation, when the CAN communication becomes upset between the integrated controller 20 and the motor controller 22 during the EV mode, and the signals cannot be exchanged therebetween, a shift timing to the rotation speed control, and the setting of the target MG rotation speed become unknown in the motor controller 2. For that reason, in this case, the motor controller 22 stops the PWM signal to the inverter 10, and interrupts the gate as a fail-safe operation, and sets the torque command to 0.

However, once the fail-safe operation described above is performed during the EV mode, the EV travel with the motor/generator 4 as the drive source cannot be performed. This makes it difficult that the vehicle travels to a safe place or a repair plant. Under the circumstances, in the present invention, even if the motor controller 22 cannot receive information from the external (integrated controller 20) due to the upset CAN communication, predetermined operation is performed by the motor controller 22 to provide a state in which the engine 3 can start. With this configuration, the retraction travel can be implemented with the engine 3 as the drive source without suddenly stopping the vehicle.

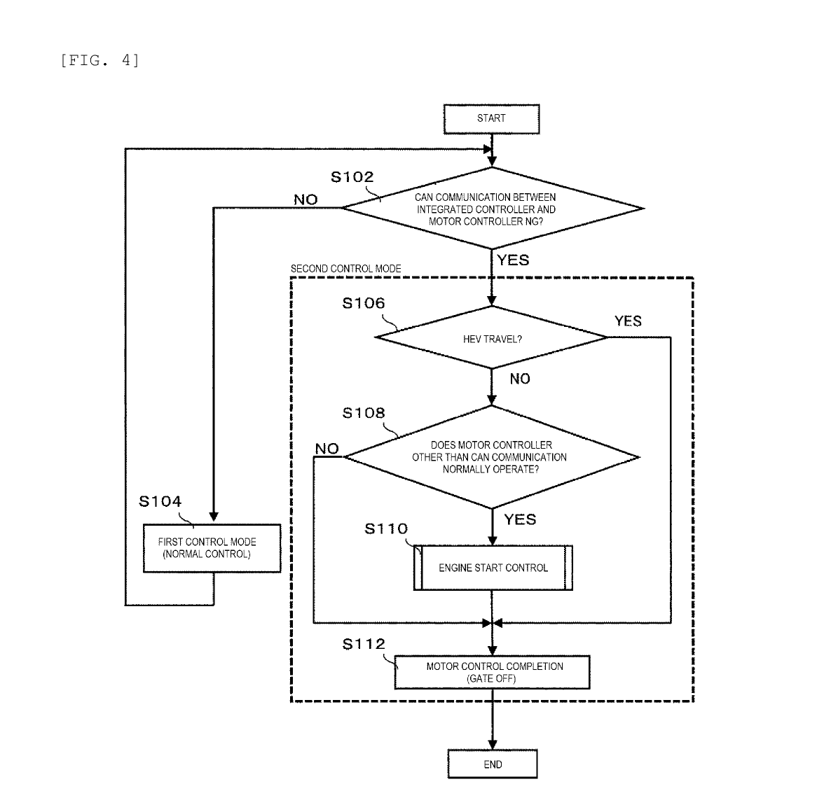

FIG. 4 is a flowchart of a motor control process executed in the motor controller 22.

In Step S102, with the use of the communication abnormality detection unit 201, it is determined whether the CAN communication with the integrated controller 20 is abnormal, or not. If it is determined that the CAN communication is normal, the flow proceeds to Step S104, and a normal control for controlling the motor/generator 4 on the basis of the command from the integrated controller 20 is implemented as a first control mode in Step S104. On the other hand, if it is determined that the CAN communication is abnormal, the flow proceeds to Step S106, and a second control mode for controlling the motor/generator 4 on the basis of the control information stored in advance is implemented in Step S106 and subsequent steps.

A known CAN communication failure diagnosis can be used in the determination in Step S102 of whether the CAN communication is abnormal, or not. For example, if a signal from the integrated controller 20 is interrupted for a given time or longer, it is determined that the CAN communication is abnormal. Also, it is preferable that the CAN communication abnormality can be recognized even in the integrated controller 20 at the same timing. Specifically, when signal interruption occurs at the same time as that when the motor controller 22 is used in the determination of Step S102, it can be determined that the CAN communication is abnormal even in the integrated controller 20. Further, taking a case in which only reception in the motor controller 22 becomes abnormal into account, if the motor controller 22 determines that the CAN communication is abnormal, the information may be transmitted from the motor controller 22 to the integrated controller 20. With this configuration, it can be determined that the CAN communication is abnormal by each of the motor controller 22 and the integrated controller 20. As an example of the CAN communication abnormality in which a motor control command value from the integrated controller 20 cannot be normally received in the motor controller 22, there is a CAN communication upset in which the CAN communication is interrupted. In addition, for example, in the case where the motor control command value from the integrated controller 20 is indicative of an abnormal value, it is preferably determined that the CAN communication is abnormal, likewise.

In Step S106, it is determined whether the current travel mode is the HEV mode, or not. If it is determined that the current travel mode is the HEV mode, that is, if the engine 3 is now operating, there is no need to implement the motor control for starting the engine 3. Therefore, in this case, the flow proceeds to Step S112, and the PWM signal to the inverter 10 stops to turn off the gate in Step S112, to thereby stop the motor/generator 4 under the control. Then, the motor control process in FIG. 4 is completed. Thereafter, in the vehicle, the retraction travel is performed with the engine 3 as the drive source without use of the motor/generator 4. Also, in the case where the travel mode is the WSC mode, if the engine 3 is operating, the flow proceeds to Step S112 as with the HEV mode. On the other hand, if it is determined that the current travel mode is not the HEV mode, that is, in the EV mode where the engine 3 is stopping, because there is a need to start the engine 3 for performing the retraction travel, the flow proceeds to Step S108.

The determination of the travel mode in Step S106 can be performed by receiving information of the travel mode or the engagement information of the first clutch CL1 from the integrated controller 20. The motor controller 22 can determine whether the current travel mode is the HEV mode, or not, on the basis of those pieces of information received immediately before the CAN communication is abnormal.

Also, the travel mode may be determined by the motor controller 22 alone with no use of the information from the integrated controller 20. For example, the travel mode can be determined by the integration result of the motor torque. In general, different SOC management systems are set between the EV mode and the HEV mode. That is, in the EV travel, because a drive force of the motor/generator 4 is used with the consumption of the SOC of the battery 19 for traveling, the operation is conducted so that an integrated value of a positive torque (power running torque) is larger, and an integrated value of a negative torque (regenerative torque) is smaller. On the contrary, in the HEV travel, in order to maintain or increase the SOC of the battery 19, the drive force of the engine 3 is increased, and the motor/generator 4 is positively regenerated. For that reason, the operation is conducted so that the integrated value of the negative torque (regenerative torque) is larger, and the integrated value of the positive torque (power running torque) is smaller. With the use of this operation, a latest integrated value of the motor torque in the motor/generator 4 is observed with the result that it can be determined whether the travel mode is the EV mode or the HEV mode. For example, if the integrated value of the regenerative torque is larger, and the integrated value of the power running torque is smaller, it can be determined that the travel mode is the HEV mode. On the contrary, if the integrated value of the regenerative torque is smaller, and the integrated value of the power running torque is larger, it can be determined that the travel mode is the EV mode.

In Step S108, in the control of the motor/generator 4, it is determined whether a failure occurs in a portion other than the CAN communication, or not. When the engine start control is performed in Step S110 which will be described later, there is required that the motor controller 22 can accurately control the motor/generator 4. However, for example, if the resolver 12 or the current sensor 210 is in failure, the motor/generator 4 cannot be accurately controlled. For that reason, if such a failure occurs, the flow proceeds to Step S112 to turn off the gate, and the motor/generator 4 stops to complete the motor control process. On the other hand, if no failure occurs in the portion other than the CAN communication, and the motor/generator 4 can be controlled in the motor controller 22, the flow proceeds to Step S110.

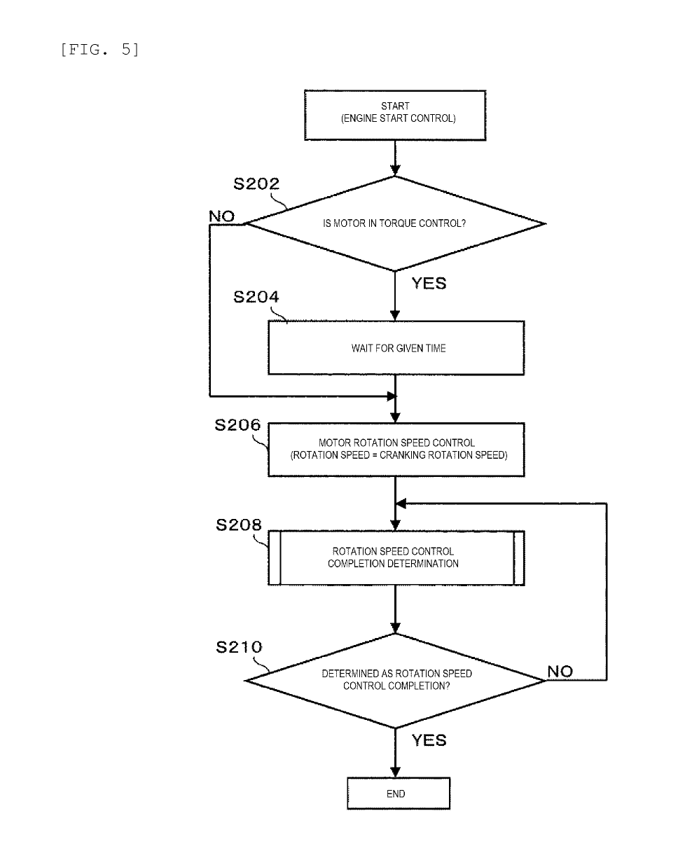

In Step S110, the motor/generator 4 is subjected to the engine start control for starting the engine 3. In the engine start control, the rotation speed of the motor/generator 4 is controlled according to the target rotation speed stored in advance to crank the engine 3 so that the engine 3 can start. The detailed processing content in Step S110 will be described below in detail with reference to a flowchart of FIG. 5.

After the engine start control in Step S110 has been completed, in subsequent Step S112, as described above, the PWM signal to the inverter 10 stops to turn off the gate. As a result, the motor/generator 4 is controlled to stop. Thereafter, the motor control process in FIG. 4 is completed, and the retraction travel is conducted on the vehicle with the engine 3 as the drive source with no use of the motor/generator 4.

In a flowchart of FIG. 4 described above, it is determined whether the current travel mode is the HEV mode, or not, in Step S106, but this processing can be omitted. In this case, while the engine start control is being conducted in Step S110, even if during the HEV travel, the rotation speed of the motor/generator 4 is controlled by the motor controller 22 according to a given rotation speed, and the second clutch CL2 is controlled by the integrated controller 20 into the disengagement or slip state. For that reason, the drivability of the vehicle is deteriorated without reflection of the drive force in this period as required by the driver. However, because the engine 3 does not stop, the retraction travel can be performed after the completion of the engine start control.

Subsequently, the details of the engine start control performed in the above Step S110 will be described with reference to FIG. 5. FIG. 5 is a flowchart of the engine start control.

In Step S202, it is determined whether the current control mode for the motor/generator 4 is the torque control, or not. If the current control mode is the torque control, the flow proceeds to Step S204, and the process waits for a given time in Step S204. In this situation, it is preferable that the motor controller 22 holds a previous control state for the motor/generator 4. That is, in this situation, because the CAN communication with the integrated controller 20 is abnormal, and the torque value currently required in the motor/generator 4 is unknown, the torque control is continued with the use of the torque command value immediately before the CAN communication becomes abnormal. Alternatively, taking the safety into account, the operation of gradually reducing the torque depending on an elapsed time may be performed.

The standby time in Step S204 is ensured to prevent an adverse effect on the drive side when the motor/generator 4 shifts from the torque control to the rotation speed control in Step S206 which will be described later. The standby time can be determined according to a time since the integrated controller 20 detects the abnormality of the CAN communication until the second clutch CL2 is brought into the disengagement or slip state. During the torque control, the second clutch CL2 is completely engaged, and the generated torque from the motor/generator 4 is completely transmitted to the drive side as the drive force. Under this situation, if the motor/generator 4 shifts from the torque control to the rotation speed control immediately when the CAN communication becomes abnormal, and the control for setting a given cranking rotation speed to a target rotation speed is executed on the motor/generator 4 in Step S206, there occurs such a drawback that the rotation speed of the drive side is rapidly changed, and the travel speed of the vehicle is also rapidly changed according to the change in the rotation speed. That is, if the rotation speed (primary rotation speed) of the primary pulley on the transmission input shaft IN side in the automatic transmission CVT is higher than the cranking rotation speed, the rotation speed control is conducted so that the rotation speed of the motor/generator 4 is reduced to the cranking rotation speed, as a result of which the vehicle is rapidly decelerated. Also, conversely, if the primary rotation speed is lower than the cranking rotation speed, the rotation speed control is conducted so that the rotation speed of the motor/generator 4 increases to the cranking rotation speed, as a result of which the vehicle is rapidly accelerated. Under the circumstances, in order to prevent the above drawback, after the time since the CAN communication becomes abnormal until the second clutch CL2 becomes in the disengagement or slip state is ensured in Step S204, the motor/generator 4 shifts to the rotation speed control.

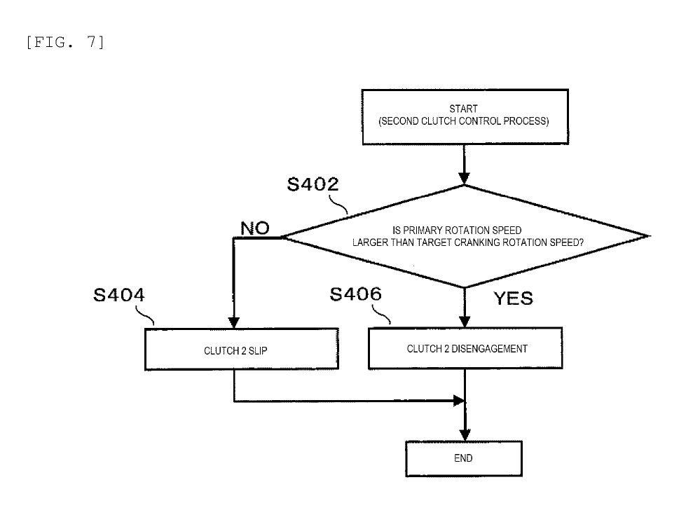

FIG. 7 is a flowchart of a second clutch control process executed for the integrated controller 20 to control the second clutch CL2 during the standby time in Step S204. At a start time of this flowchart, the second clutch CL2 is in the engagement state.

If the integrated controller 20 detects the abnormality in the CAN communication with the motor controller 22, the integrated controller 20 starts processing illustrated in a flowchart of FIG. 7. In Step S402, it is determined whether the primary rotation speed is larger than the cranking rotation speed which is the target rotation speed in the rotation speed control of the motor/generator 4, or not. If the primary rotation speed is larger than the cranking rotation speed, because the integrated controller 20 cannot transmit the generated torque of the motor/generator 4 to the drive side during the rotation speed control, the flow proceeds to Step S406. In Step S406, the integrated controller 20 outputs the target CL2 torque command to the CVT controller 23, and disengages the second clutch CL2. On the other hand, if the primary rotation speed is smaller than the cranking rotation speed, because the integrated controller 20 can transmit the generated torque of the motor/generator 4 to the drive side during the rotation speed control, the flow proceeds to Step S404. In Step S404, the integrated controller 20 outputs the target CL2 torque command to the CVT controller 23, and controls the second clutch CL2 in the slip control.

In Step S404, it is preferable to maintain a plus slip state in which the motor rotation speed Nm is larger than the primary rotation speed, and a difference between those rotation speeds is equal to or larger than a given difference α. For that reason, in Step S402, it may be determined whether the primary rotation speed is larger than “cranking rotation speed+difference α”, or not. Alternatively, the determination in Step S404 may be omitted, and Step S406 may be executed in all of the cases without depending on the primary rotation speed to disengage the second clutch CL2.

Now, returning to the description of the flowchart of the engine start control in FIG. 5, the motor controller 22 waits for a given time in Step S204, and thereafter proceeds to Step S206. In Step S206, the motor controller 22 sets a given cranking rotation speed as the target rotation speed, and performs the rotation speed control for rotating the motor/generator 4 according to the target rotation speed. In this example, the rotation speed control torque calculation unit 301 of FIG. 3 calculates the torque command value corresponding to the difference between the motor rotation speed Nm and the cranking rotation speed on the basis of the information on the cranking rotation speed stored in the motor controller 22 in advance. With the use of the torque command value, the motor controller 22 controls the motor/generator 4 to rotate in a given rotating state corresponding to the cranking rotation speed.

If it is determined in Step S202 that the current control mode is not the torque control, but the rotation speed control, the second clutch CL2 has already been put into the slip state. For that reason, there is no need to ensure the standby time as in Step S204, and the cranking rotation speed can be set to the target rotation speed immediately. In this situation, a standby time may be provided, but can be set to a value different from the standby time in Step S204.

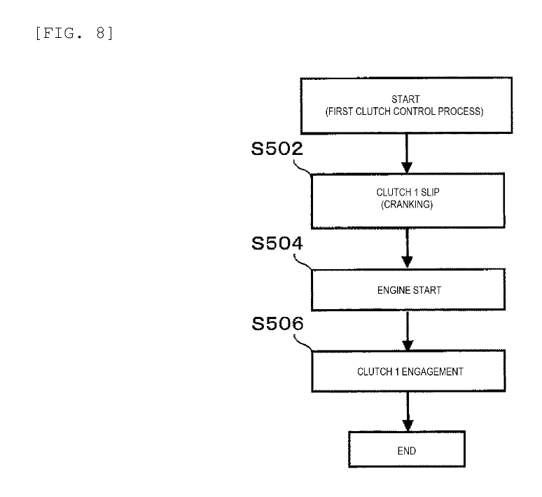

FIG. 8 is a flowchart of a first clutch control process executed for the integrated controller 20 to control the first clutch CL1 and start the engine 3 during the rotation speed control in Step S206. At the start time of the flowchart, the first clutch CL1 is in the disengagement state.

If the integrated controller 20 detects the abnormality in the CAN communication with the motor controller 22, the integrated controller 20 executes the above-mentioned processing illustrated in the flowchart of FIG. 7 to bring the second clutch CL2 into the disengagement or slip state, and thereafter starts processing illustrated in a flowchart of FIG. 8. That is, if the motor controller 22 detects the CAN communication abnormality, the processing illustrated in the flowchart of FIG. 8 is executed by the integrated controller 20 at timing when the rotation speed control starts in Step S206 after the motor controller 22 waits for a given time in Step S304, and the control of the first clutch CL1 starts. In Step S502, the integrated controller 20 outputs the target CL1 torque command to the first clutch controller 5, and gradually slips the first clutch CL1 from the disengagement state into the engagement state. With the above configuration, the integrated controller 20 gradually transmits the rotation of the motor/generator 4 to the engine 3, and cranks the engine 3. Subsequently, in Step S504, the integrated controller 20 outputs a given command to the engine controller 21, starts the fuel injection and the ignition in the cranked engine 3, and starts the engine 3. In this situation, the start timings of the fuel injection and the ignition may be determined according to any one of the engine controller 21 and the integrated controller 20. After it is confirmed that the engine 3 starts in Step S504, the flow proceeds to Step S506. In Step S506, the integrated controller 20 outputs the target CL1 torque command to the first clutch controller 5, and completely engages the first clutch CL1.

The operation of the first clutch CL1 by the first clutch control process described above is identical with the operation of the first clutch CL1 in the engine start control in shifting from the EV mode to the HEV mode in the normal control when the CAN communication between the integrated controller 20 and the motor controller 22 is normal. In this example, in the first clutch control process of FIG. 8, since the CAN communication between the integrated controller 20 and motor controller 22 is abnormal, the cooperative control between the integrated controller 20, and each of the motor controller 22 and the first clutch controller 5 cannot be performed. Therefore, in order to reduce the shock at the time of starting the engine, the first clutch CL1 may be operated in the first clutch control process under an operating condition different from that in the normal control.

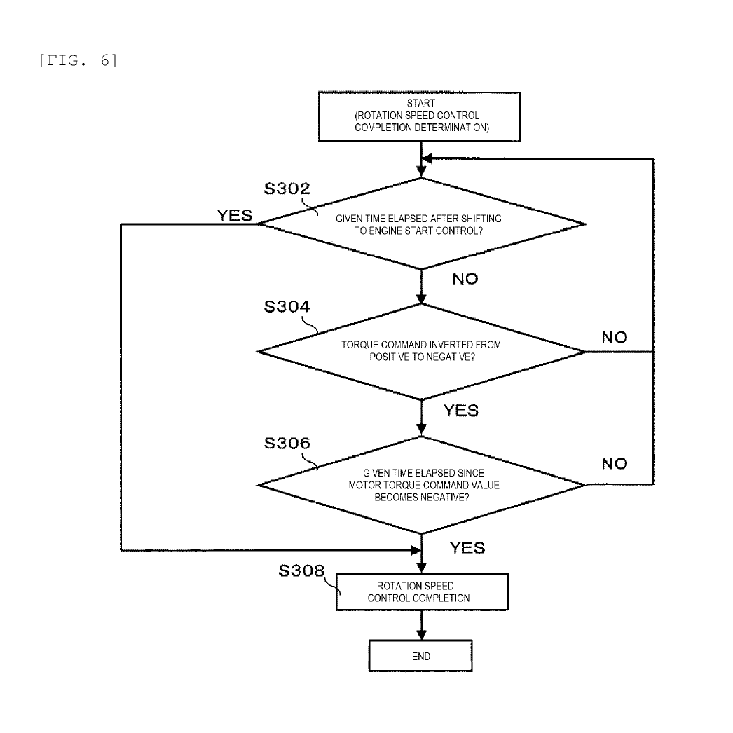

Now, returning to the description of the flowchart of the engine start control in FIG. 5, after the motor controller 22 starts the rotation speed control of the motor/generator 4 in Step S206, the motor controller 22 performs the processing for determining the rotation speed control completion in Step S208. In this processing, it is determined whether the engine 3 has started, or not, and if it is determined that the engine 3 has started, it is determined that the rotation speed control has been completed. The detailed processing content in Step S208 will be described in detail later with reference to a flowchart of FIG. 6. In subsequent Step S210, it is determined whether the determination of the rotation speed control completion is made, or not in step S208. If the determination of the rotation speed control completion is not made, the flow returns to Step S208 to continue the processing of the rotation speed control completion determination. On the other hand, if the determination of the rotation speed control completion is made, the rotation speed control of the motor/generator 4 started in Step S206 is completed. Then, the engine start control in FIG. 5 is completed to proceed to Step S112 in FIG. 4, and the gate turns off to stop the motor/generator 4 under the control.

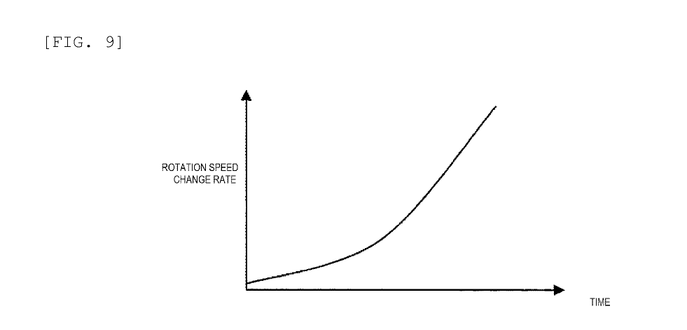

In the above engine start control, after the motor controller 22 waits for a given time in Step S204, the rotation speed control of the motor/generator 4 is performed so that the rotation speed of the motor/generator 4 becomes a given cranking rotation speed in Step S206. However, even after the motor controller 22 has waited for the given time in Step S204, the second clutch CL2 may be still kept in the engagement state due to the hydraulic variation. Assuming the above circumstances, when the rotation speed of the motor/generator 4 is controlled in Step S206, it is preferable that the rotation speed of the motor/generator 4 is changed from a value of the control start time to the cranking rotation speed at a given change rate, to thereby prevent a rapid change in the motor rotation speed with the limit of a change in the motor rotation speed. In this case, an example of the rotation speed change rate is illustrated in FIG. 9. FIG. 9 illustrates an example in which a change rate in the motor rotation speed is relatively small at the time of starting the rotation speed control, and the change rate in the motor rotation speed gradually increases according to the elapsed time from the start time. With this configuration, an adverse effect (rapid acceleration, rapid deceleration) on the vehicle behavior can be reduced, and the anxiety of the driver can be minimized.

Further, the above change rate may be changed according to the magnitude of the torque in the motor/generator 4, and a locus of the torque change. With the combination of those processing together, the adverse effect on the vehicle behavior can be further suppressed. For example, if the disengaging operation of the second clutch CL2 is delayed for some reason, since the second clutch CL2 is in the engagement state, there is a need to change the motor rotation speed including the driving shaft at the time of the rotation speed control. For that reason, the motor torque larger than that when the second clutch CL2 is in the disengagement state is required. Under the circumstances, the state of the second clutch CL2 is estimated from the magnitude of the motor torque, as a result of which if it is determined that the amount of disengagement of the second clutch CL2 is small, the change rate of the motor rotation speed in the rotation speed control is reduced below the usual change rate. With this configuration, a change in the vehicle behavior can be more reduced.

Also, in the above engine start control, the motor controller 22 waits for the given time in Step S204 to wait until the second clutch CL2 becomes in the disengagement state, and thereafter the rotation speed control of the motor/generator 4 is performed in Step S206. Alternatively, the information indicative of the state of the second clutch CL2 transmitted from the CVT controller 23 may be received in the motor controller 22, and the motor controller 22 may determine the timing when the second clutch CL2 becomes in the disengagement state on the basis of the received information to determine the timing when the rotation speed of the motor/generator 4 is controlled. According to this configuration, the timing when shifting to the rotation speed control in Step S206 upon detecting the CAN communication abnormality can be more accurately grasped.

Further, in the rotation speed control in Step S206, or the rotation speed control completion determination process in Step S208, the information related to a control state of the first clutch CL1 and the engine 3 may be transmitted and received among the first clutch controller 5, the engine controller 21, and the motor controller 22. With the use of the above information, the control suitable for the operating timing of the respective devices can be accurately performed. For example, during the rotation speed control in Step S206, a cranking enable signal indicating that the motor/generator 4 reaches the target rotation speed is transmitted from the motor controller 22 to the first clutch controller 5. With the use of this signal, the first clutch controller 5 can accurately control the shift timing to the slip operation of the first clutch CL1. Also, in the rotation speed control completion determination process in Step S208, an engine complete explosion signal indicating that the engine 3 is in a complete explosion state is transmitted from the engine controller 21 to the motor controller 22, and a first clutch engagement completion signal indicating that the engagement of the first clutch CL1 has been completed is transmitted from the first clutch controller 5 to the motor controller 22. With the use of at least any one of those signals, the motor controller 22 can determine the rotation speed control completion at accurate timing. Those signals can be transmitted and received between the motor controller 22 and the respective controllers, for example, with the use of a CAN signal or a hard wire. In the case of the CAN communication, the continuous communication may be performed. On the other hand, if the continuous communication is difficult from the viewpoint of the communication load, the communication of the above signal may start with a fact that the CAN communication between the integrated controller 20 and the motor controller 22 becomes abnormal as a trigger.

Subsequently, a description will be given of the details of the rotation speed control completion determination process conducted in the above Step S208 with reference to FIG. 6. FIG. 6 is a flowchart of the rotation speed control completion determination process.

After the engine 3 starts in Step S504 of FIG. 8, and the first clutch CL1 is engaged in subsequent Step S506, the rotation speed control of the motor/generator 4 is continued as it is. In this case, because this rotating state does not follow the command from the integrated controller 20, this rotating state prevents a request from the driver from being reflected on the driving state of the vehicle. For that reason, it is preferable that after the engine 3 starts, the rotation speed control of the motor/generator 4 is completed as soon as possible to provide a gate off-state, and the retraction travel of the vehicle is realized with only the engine 3 as the power source. Under the circumstances, the following processing is performed as the process of the rotation speed control completion determination so that the motor controller 22 can quickly determine that the engine 3 starts.

In Step S302, a time since the engine start control starts in Step S110 of FIG. 4 is measured, and it is determined whether a given permissible time has been elapsed, or not, on the basis of the measured time. As a result, if the measured time is lower than the permissible time, the flow proceeds to Step S304, and if the permissible time has been elapsed, the flow proceeds to Step S308. The permissible time in the determination of Step S302 is a worst value permitted since the engine start control starts until the engine 3 starts, and if the measured time exceeds the permissible time, the motor/generator 4 turns off the gate. The permissible time is not set to a fixed value, but may be variable according to a vehicle parameter. For example, because the time until the start of the engine 3 is completed is different between an extremely low temperature time and a room temperature time, the permissible time may be changed according to water temperature information or oil temperature information. Also, because the operating speed of the first clutch CL1 when the engine 3 is cranked is also changed according to the temperature, the permissible time may be changed further taking hydraulic information into account.

If the flow proceeds to Step S304 from Step S302, in Step S304 and subsequent Step S306, it is determined whether the engine 3 starts, or not. When the engine 3 is cranked by the motor/generator 4 to start the engine 3, the motor/generator 4 needs to generate a large positive torque (power running torque) exceeding the friction of the engine 3. On the other hand, when the engine 3 starts to start the generation of the engine torque, in order to suppress the rotation speed in turn, the motor/generator 4 generates a negative torque (regenerative torque). Under the circumstances, when the torque command calculated by the torque command calculation unit 202 in FIG. 3 within the motor controller 22 switches from a positive torque to a negative torque, it can be determined that the engine 3 starts. Alternatively, the positive and negative of the torque command may be determined according to, for example, a value of the sensor information from the current sensor 210 in addition to the torque command value of the motor controller 22 to determine the start of the engine 3.

If the torque command value is not inverted, that is, the positive torque in Step S304, because the engine 3 is still being cranked, the flow returns to Step S302. On the other hand, if the torque command value is inverted from the positive to the negative, it is determined that the engine 3 starts, and the flow proceeds to step S306.

In Step S306, it is determined whether a state of the negative torque has been elapsed for a given time in the motor/generator 4, or not. Even if the engine 3 does not start, the torque from the motor/generator 4 may be inverted from the positive torque to the negative torque. For example, the rotation speed of the motor/generator 4 exceeds the target rotation speed during the cranking (overshoot) depending on the method of the rotation speed control, and in order to suppress the overshoot, the negative torque may be generated. Under the circumstances, in order to surely determine that the engine 3 starts in Step S306, it is determined whether the negative torque is continuously generated from the motor/generator 4 for a given time, or longer, or not. As a result, if the generated time of the negative torque is equal to or longer than the given time, it is determined the engine 3 starts, and the flow proceeds to Step S308, but if not so, the flow returns to Step S302. In the above description, the start of the engine 3 is determined according to a change in the magnitude of the motor torque. Alternatively, a change in a rate of the power running, and the regeneration of the motor torque may be used. Because the rate of the power running torque becomes larger during cranking while the rate of the regenerative torque becomes larger after the engine starts, the start of the engine 3 can be determined by application of this fact.

The motor controller 22 detects the torque of the motor/generator 4 through the processing of Steps S304 and S306 as described above, and can determine whether the start of the engine 3 has been completed, or not, on the basis of the detected torque. In Step S308, it is determined that the rotation speed control has been completed, and the rotation speed control completion determination process in FIG. 6 is completed.

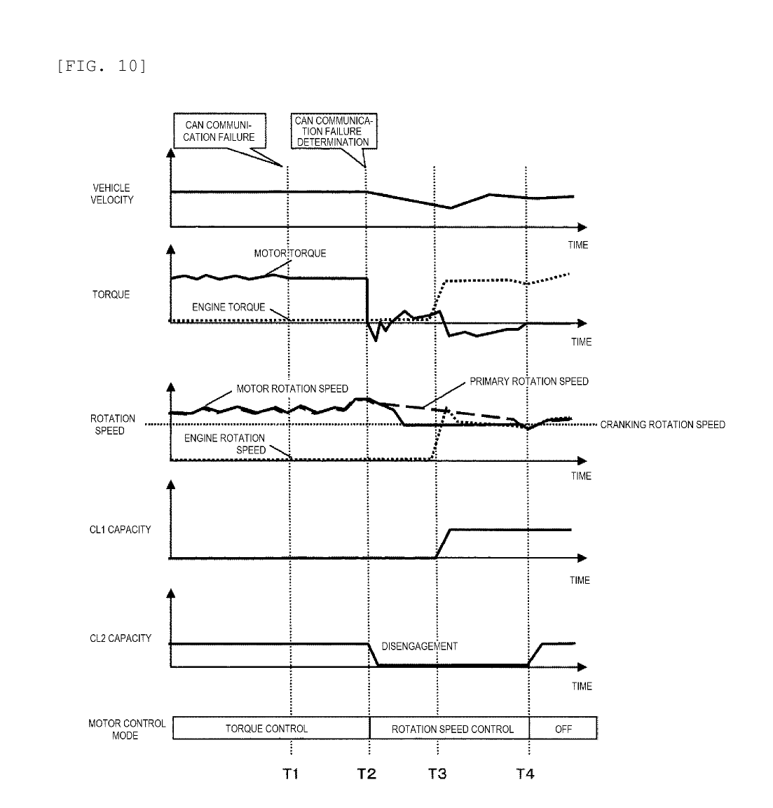

FIG. 10 is a diagram illustrating an example of an operation time chart when the CAN communication is interrupted in the hybrid electric vehicle according to this embodiment described above. The vehicle operation when the CAN communication is upset will be described below with reference to FIG. 10.

At a time T1 during the EV mode, it is assumed that the CAN communication is interrupted between the integrated controller 20 and the motor controller 22. In this situation, because the motor torque command value is not updated in the motor controller 22, the control is continued with the use of a previous command value. In the subsequent process, it is assumed that an interruption state of the CAN communication is continued, and the abnormality of the CAN communication is determined at a time T2. In this situation, it is preferable that the abnormality of the CAN communication can be recognized in the motor controller 22 and the integrated controller 20 at the same timing.

When the abnormality of the CAN communication is determined at the time T2, the integrated controller 20 outputs the target CL2 torque command to the CVT controller 23 in Step S406 of FIG. 7 so that the second clutch CL2 is disengaged, and instructs the CVT controller 23 to disengage the second clutch CL2. On the other hand, the motor controller 22 puts the motor/generator 4 into the rotation speed control state in Step S206 of FIG. 5, and also sets the target rotation speed to a predetermined cranking rotation speed. In this situation, as described above, the motor controller 22 limits the change rate of the motor rotation speed to reduce the motor rotation speed, taking a variation in the disengagement speed of the second clutch CL2 into account. Because the motor torque is not transmitted to the drive side by disengaging the second clutch CL2, the primary rotation speed is gradually reduced.

When it comes to a time T3 in a state where the rotation speed control corresponding to the cranking rotation speed is conducted on the motor/generator 4, the integrated controller 20 outputs the target CL1 torque command for cranking to the first clutch controller 5 in Step S502 in FIG. 8, and gradually slips the first clutch CL1 from the disengagement state into the engagement state. With this operation, the first clutch CL1 is gradually engaged, and the engine 3 is cranked to increase the engine rotation speed.

When the engine 3 is completely exploded to start up in Step S504, in order to suppress the engine rotation speed, the motor/generator 4 generates the negative toque. At a time T4 when the negative torque state is continued for a given time, the motor controller 22 completes the rotation speed control of the motor/generator 4, and turns off the gate to set the motor torque to 0 in Step S112 of FIG. 4. Thereafter, the motor controller 22 gradually changes the second clutch CL2 into the engagement state from the disengagement state to transmit the torque from the engine 3 to the drive side. As a result, the retraction travel using the engine 3 starts in the vehicle. In order to quickly output the drive torque, the operation of engaging the second clutch CL2 may be performed before the time T4. However, in this case, there is a need to engage the second clutch CL2 after the complete explosion of the engine 3 at the earliest.

In the embodiment described above, the cranking rotation speed is set to the predetermined rotation speed, but if the primary rotation speed information can be received from the CVT controller 23, it is possible to set the cranking rotation speed corresponding to the primary rotation speed. In order that the torque can be transmitted to the drive side even during the engine start, there is a need to set the motor rotation speed to be always higher than the primary rotation speed. Under the circumstances, if a rotating speed including a difference between the primary rotation speed received from the CVT controller 23 and the necessary motor rotation speed in the primary rotation speed is set as the cranking rotation speed, the engine 3 starts without interrupting the drive force, and can shift to the retraction travel.

The embodiment described above obtains the following operational advantages.

(1) The motor controller 22 is mounted on the hybrid electric vehicle having the engine 3 and the motor/generator 4, and controls the motor/generator 4. The motor/generator 4 is used to drive the drive wheels of the vehicle, and start the engine 3. The vehicle includes the motor controller 22, the engine controller 21 that controls the engine 3, and the integrated controller 20 that is communicatively connected to the motor controller 22 and the engine controller 21, and outputs a command corresponding to a driving state of the vehicle to the motor controller 22 and the engine controller 21. The motor controller 22 implements the first control mode for controlling the motor/generator 4 on the basis of the command from the integrated controller 20 if the CAN communication with the integrated controller 20 is normal (Step S104). Also, the motor controller 22 implements the second control mode for controlling the motor/generator 4 on the basis of the control information stored in advance to allow the motor/generator 4 to start the engine 3 when the engine 3 is in stop if the CAN communication with the integrated controller 20 is abnormal (Step S110). With this configuration, if the control of the motor/generator 4 is disabled, the motor/generator 4 can be appropriately stopped, and the drive wheels are driven by the engine 3 to perform the retraction travel.

(2) If the engine 3 is in stop, the motor controller 22 controls the motor/generator 4 so as to rotate in a given rotating state in the second control mode (Step S206). Also, if the engine 3 is in operation, the motor controller 22 controls the motor/generator 4 so as to stop in the second control mode (Step S112). With this configuration, the motor controller 22 can appropriately control the operation of the motor/generator 4 according to the operating state of the engine 3.

(3) If the engine 3 is in stop, the motor controller 22 controls the motor/generator 4 so as to rotate in the given rotating state in the second control mode (Step S206), and thereafter controls the motor/generator 4 so as to stop in Step S112. With this configuration, after the operation of the motor/generator 4 becomes unnecessary, the motor controller 22 can appropriately stop the motor/generator 4.

(4) The motor controller 22 performs the rotation speed control for rotating the motor/generator 4 according to the given target rotation speed, to thereby control the motor/generator 4 so as to rotate in the given rotation state in Step S206. With this configuration, the engine 3 is appropriately cranked by the rotation of the motor/generator 4, and the engine 3 can start.

(5) The motor controller 22 determines whether the start of the engine 3 has been completed, or not (Steps S304, S306), and if it is determined that the start has been completed, the motor controller 22 completes the rotation speed control of Step S206 (Step S308). With this configuration, after the engine 3 has started, the motor controller 22 can surely complete the unnecessary rotation speed control of the motor/generator 4.

(6) The motor controller 22 detects the torque of the motor/generator 4, and determines whether the start of the engine 3 has been completed, or not, on the basis of the detected torque, in Steps S304, S306. With this configuration, the motor controller 22 can accurately determine whether the start of the engine 3 has been completed, or not.

(7) When performing the rotation speed control in Step S206, the motor controller 22 can change the rotation speed of the motor/generator 4 to the target rotation speed at a given change rate. Specifically, the motor controller 22 can change the above change rate according to the elapsed time since the rotation speed control starts in Step S206. With this configuration, the

an adverse effect on the vehicle behavior caused by rapidly changing the motor rotation speed can be reduced, and the anxiety of the driver can be minimized.

(8) Also, the motor controller 22 detects the torque of the motor/generator 4, and can determine the above change rate on the basis of the detected torque. With this configuration, the adverse effect on the vehicle behavior can be further reduced.

(9) The vehicle further includes the first clutch CL1 that engages or disengages between the engine 3 and the motor/generator 4, the first clutch controller 5 that controls the first clutch CL1, the second clutch CL2 that engages or disengages between the motor/generator 4 and the drive wheels, and the CVT controller 23 that controls the second clutch CL2. When the second control mode is implemented by the motor controller 22, the first clutch CL1 engages the engine 3 with the motor/generator 4 (Step S502), and the second clutch CL2 disengages the motor/generator 4 from the drive wheels (Step S406). In this state, the engine 3 is started by the motor/generator 4 (Step S504). With this configuration, the rotation of the motor/generator 4 is appropriately transmitted to the engine 3 to crank the engine 3, and the engine 3 can start. Also, the rotation of the motor/generator 4 is prevented from being transmitted to the drive wheels of the vehicle while cranking the engine 3, thereby being capable of avoiding the adverse effect on the vehicle behavior.

(10) If the engine 3 is in stop, the motor controller 22 controls the motor/generator 4 to rotate in the given rotating state in the second control mode in Step S206. Thereafter, the motor controller 22 performs the processing of the rotation speed control completion determination in Step S208, and can control the motor/generator 4 to stop in Step S112, according to the signal from at least one of the engine controller 21 and the first clutch controller 5. With this configuration, after the engine 3 starts, the motor controller 22 can stop the motor/generator 4 at an accurate timing.

(11) The motor controller 22 is mounted on the hybrid electric vehicle having the engine 3 and the motor/generator 4, and controls the motor/generator 4. If the communication with the integrated controller 20 as the external control device is abnormal, the motor controller 22 switches from the first control mode for controlling the motor/generator 4 on the basis of the command from the integrated controller 20 to the second control mode for controlling the motor/generator 4 on the basis of the control information stored in advance (Steps S102, S104, S110, S112). With this configuration, as described above, if the control of the motor/generator 4 is disabled, the motor controller 22 can appropriately stop the motor/generator 4, and also perform the retraction travel by driving the drive wheels with the engine 3.

In the embodiment described above, if the CAN communication between the integrated controller 20 and the motor controller 22 is abnormal, the motor control process in FIG. 4 is executed in the motor controller 22 whereby the rotation speed of the motor/generator 4 is controlled at the given rotation speed to start the engine 3. However, if the CAN communication between the integrated controller 20 and the motor controller 22 is abnormal, the motor controller 22 may receive the information necessary for controlling the motor/generator 4 through another route, for example, another controller such as the first clutch controller 5. Alternatively, the motor controller 22 may control the motor/generator 4 on the basis of the information transmitted from the controller other than the integrated controller 20.

The embodiments and various modifications described above are exemplary, and the present invention is not limited to those contents as far as the features of the invention are not impaired.

### LIST OF REFERENCE SIGNS

3 engine
4 motor/generator
5 first clutch controller
6 first clutch hydraulic unit
9 second clutch hydraulic unit
10 inverter
11 engine speed sensor (crank angle sensor)
12 resolver
14 hydraulic actuator
14a piston
15 first clutch stroke sensor
16 accelerator opening sensor
17 vehicle velocity sensor
19 battery
20 integrated controller
21 engine controller (ECM)
22 motor controller
23 CVT controller
24 brake controller
25 battery controller
51 wheel speed sensor
52 brake stroke sensor
CL1 first clutch
CL2 second clutch
201 communication abnormality detection unit
202 torque command calculation unit
203 motor rotation speed calculation unit
204 motor current detection unit
205 DC voltage detection unit
206 current command calculation unit
207 current control calculation unit
208 PWM duty calculation unit
301 rotation speed control torque calculation unit
302 torque control torque calculation unit
303 rotation speed control/torque control selection unit
304 upper/lower limit unit

1. A motor control device that is mounted on a vehicle which is a hybrid electric vehicle having an engine and a motor, for controlling the motor, wherein
the motor is used to drive drive wheels of the vehicle, and start the engine,
the vehicle includes:
the motor control device;
an engine control device that controls the engine; and
an integrated control device that is communicatively connected to the motor control device and the engine control device, and outputs a command corresponding to a driving state of the vehicle to the motor control device and the engine control device,
the motor control device implements a first control mode for controlling the motor on the basis of the command from the integrated control device if a communication with the integrated control device is normal, and
implements a second control mode for controlling the motor on the basis of control information stored in advance to allow the motor to start the engine when the engine is in stop if the communication with the integrated control device is abnormal.

2. The motor control device according to claim 1, wherein
if the engine is in stop, the motor is controlled to rotate in a given rotating state in the second control mode, and
if the engine is in operation, the motor is controlled to stop in the second control mode.

3. The motor control device according to claim 2, wherein
if the engine is in stop, in the second control mode, after the motor is controlled to rotate in the given rotating state, the motor is controlled to stop.

4. The motor control device according to claim 2, wherein
a rotation speed control for rotating the motor according to a given target rotation speed is performed so that the motor is controlled to rotate in the given rotating state.

5. The motor control device according to claim 4, wherein
it is determined whether the engine has started, or not, and
if it is determined that the engine has started, the rotation speed control is completed.

6. The motor control device according to claim 5, wherein
a torque of the motor is detected, and
it is determined whether the engine has started, or not, on the basis of the detected torque of the motor.

7. The motor control device according to claim 4, wherein
when the rotation speed control is performed, the rotation speed of the motor changes to the target rotation speed at a given change rate.

8. The motor control device according to claim 7, wherein
the change rate changes according to an elapsed time since the rotation speed control starts.

9. The motor control device according to claim 7, wherein
a torque of the motor is detected, and
the change rate is determined on the basis of the detected torque of the motor.

10. The motor control device according to claim 1, wherein
the vehicle further includes:
a first engaging/disengaging unit that engages or disengages between the engine and the motor;
a first engaging/disengaging control device that controls the first engaging/disengaging unit;
a second engaging/disengaging unit that engages or disengages between the motor and the drive wheels; and
a second engaging/disengaging control device that controls the second engaging/disengaging unit,
wherein when the second control mode is implemented by the motor control device, the engine and the motor are engaged with each other by the first engaging/disengaging unit, and the engine starts by the motor in a state where the motor and the drive wheels are disengaged from each other by the second engaging/disengaging unit.

11. The motor control device according to claim 10, wherein
if the engine is in stop, after the motor is controlled to rotate in a given rotating state in the second control mode, the motor is controlled to stop according to a signal from at least one of the engine control device and the first engaging/disengaging control device.

12. A motor control device that is mounted on a vehicle which is a hybrid electric vehicle having an engine and a motor, and controls the motor, wherein
if a communication with an external control device is abnormal, a first control mode for controlling the motor on the basis of a command from the external control device is switched to a second control mode for controlling the motor on the basis of control information stored in advance.
